(19) United States
(12) Patent Application Publication
(10) Pub. No.: US 2016/0344870 A1
(43) Pub. Date: Nov. 24, 2016

(54) Interactive Voice Response Valet

(71) Applicant: PAYPAL INC., San Jose, CA (US)

(72) Inventor: Rahul Nair, Austin, TX (US)

(21) Appl. No.: 14/715,658

(22) Filed: May 19, 2015

(51) Int. Cl. H04M 3/51

(52) U.S. Cl. CPC H04M 3/5191; H04M 3/5166; H04M 3/5183

(57) ABSTRACT

Methods, systems, and computer program products for providing interactive voice response (IVR) valet services are disclosed. A computer-implemented method may include receiving data associated with an interactive voice response system, generating a graphical user interface that allows a user to visually select services offered by the interactive voice response system, displaying the graphical user interface for the interactive voice response system to the user, providing the user with self-service information from the interactive voice system via the graphical user interface, initiating a communication to operate the interactive voice response system on the user's behalf, operating the interactive voice response system on the user's behalf in view of a user selection received via the graphical user interface, waiting on the user's behalf when the communication involving with the interactive voice response system is on hold, and connecting the user to the communication when a live person is responsive to the communication.

### TECHNICAL FIELD

The present disclosure generally relates to computer systems and, more particularly, to automated interactive voice response (IVR) services using the Internet, specialized communication devices, and graphical user interfaces.

### BACKGROUND

An interactive voice response (IVR) system generally describes a specialized telephony system that allows a computer to interact with another party providing dual-tone multi-frequency (DTMF) tones or voice commands. For example, interactive voice response systems may automatically answer calls from callers, interact with and gather basic information from callers, and route incoming calls to an appropriate destination without human interaction or effort by the receiving party. As such, many organizations provide automated telephone service, call routing, and self-service options that extend customer service availability and reduce support costs.

While interactive voice response systems can increase the availability and operational efficiency of service providers, end-users often become frustrated with these systems. For example, consumers seeking to perform a simple task may endure multiple, lengthy audio messages and enter numerous responses before selecting a service or speaking to a live person. In addition, an interactive voice response system may not offer options that match the goals of a consumer. Further, consumers may spend even more of their time on hold waiting to speak to a live person after navigating a labyrinth of menus and associated options.

Therefore, providing new and improved communication services that simplify user interaction with interactive voice response systems and minimize the amount of unproductive time consumers spend seeking and obtaining support are of importance.

### BRIEF DESCRIPTION OF THE DRAWINGS

Various examples of the present disclosure will be understood more fully from the detailed description given below and from the accompanying drawings of various examples of the disclosure. In the drawings, like reference numbers may indicate identical or functionally similar elements. The drawing in which an element first appears is generally indicated by the left-most digit in the corresponding reference number.

FIG. 1 is a block diagram illustrating a system architecture, in accordance with various examples of the present disclosure.

FIG. 2 is a flow diagram for providing an interactive voice response (IVR) valet service, according to an example of the present disclosure.

FIG. 3 is a flow diagram for providing an interactive voice response (IVR) valet service for interactive voice response systems of different merchants, according to an example of the present disclosure.

FIG. 4 is a block diagram of an exemplary computer system that may perform one or more of the operations described herein.

### DETAILED DESCRIPTION

Systems, methods, and computer program products for providing interactive voice response (IVR) services are disclosed. People generally use interactive voice response systems when calling companies for support. Such systems usually read various menus and options aloud while a user sits and listens on a telephone. The user then may enter numeric options from a telephone keypad or speak basic voice commands to direct the interactive voice response system through numerous menus and selection options.

Users often become frustrated with interactive voice response systems because such systems are difficult to navigate and do not allow users to efficiently access support options. In addition, once a user is finally able to make a selection, the user's call is usually placed on a lengthy hold until a live representative is available. As such, the process of using and obtaining support via interactive voice response systems is both inefficient and time-consuming for users.

In an example, a communication attendant (or “valet”) system provides an electronic communication agent (or valet) that contacts and operates an interactive voice response system on behalf of a user, waits on hold for a live representative, and connects the user to the communication when the representative is ready to speak with the user. Thus, the communication attendant system frees the user from operating the interactive voice response system and waiting on hold so that the user can do more productive things with their time.

In an example, the communication attendant system receives data associated with an interactive voice response system and generates a graphical user interface that allows a user to visually select one or more services available from the interactive voice response system. The communication attendant displays the graphical user interface and receives selections from the user indicating interactive voice response system services the user wishes to utilize.

In an example, the communication attendant system initiates a communication to perform one or more operations involving the interactive voice response system on behalf of the user. The communication attendant also waits for a live person to answer the communication, if needed. Further, the communication attendant detects when a live person responds to the communication, signals a device of the user, and connects the device to the communication so the user can speak with the person.

Accordingly, aspects of the present disclosure improve the ease and efficiency of using interactive voice response systems using specialized graphical user interfaces and communication systems.

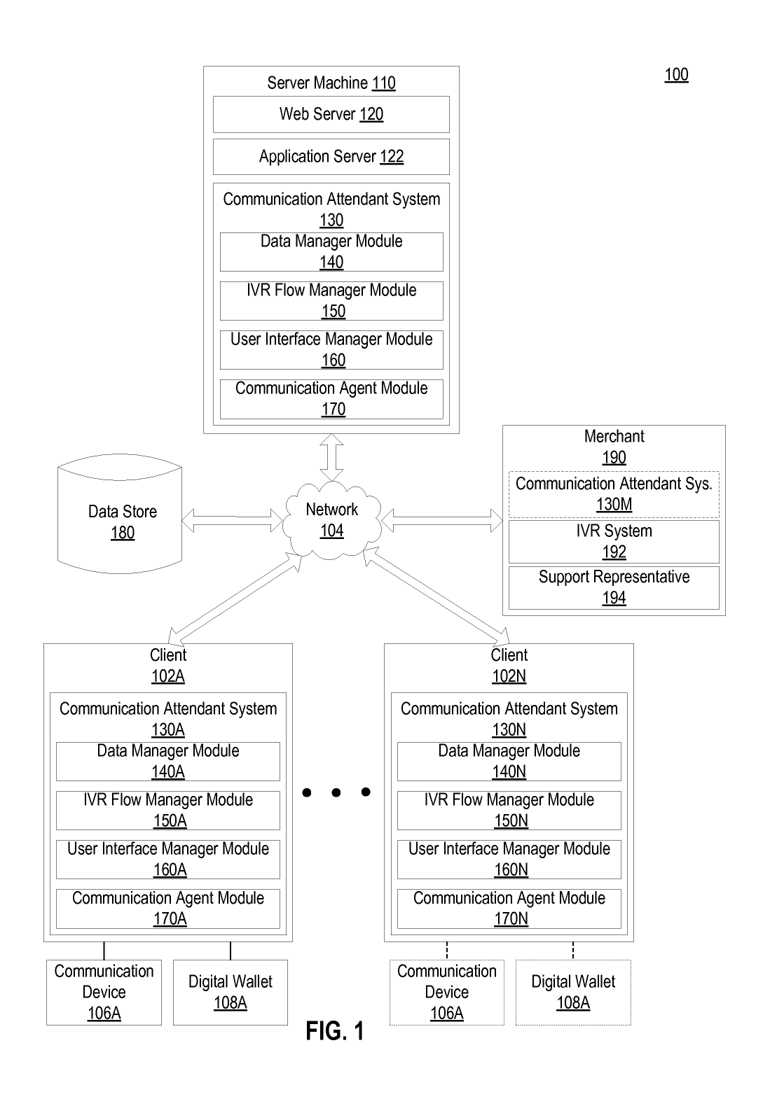

FIG. 1 illustrates an exemplary system architecture 100 in which examples of the present disclosure may be implemented. System architecture 100 includes one or more server machines 110, one or more data stores 180, one or more client machines 102A, 102N, and one or more merchants 190 or other parties connected via one or more networks 104.

Network 104 may be a public network (e.g., the Internet), a private network (e.g., local area network (LAN) or wide area network (WAN)), or any combination thereof. In an example, network 104 may include the Internet, one or more intranets, wired networks, wireless networks, and/or other appropriate types of communication networks. In one example, network 104 may comprise a wireless telecommunications network (e.g., cellular phone network) adapted to communicate with other communication networks, such as the Internet. Network 104 also may include one or more short-range wireless networks or beacon networks.

Data store 180 generally refers to persistent storage capable of storing various types of data, such as text, audio, video, and image content. In some examples, data store 180 may include a network-attached file server, while in other examples data store 180 may include other forms of persistent storage such as an object-oriented database, a relational database, and so forth.

Client machine 102A may be a personal computer (PC), laptop, mobile phone, tablet computer, server computer, wearable computing device, or any other type of computing device. Client machine 102A may run an operating system (OS) that manages hardware and software of the client machine 102A. A browser (not shown) may run on client machine 102A (e.g., on the OS of client machine 102A). The browser may be a web browser that can access content and services provided by web server 120, application server 122, or a combination of web server 120 and application server 122. Other types of computer programs and computer scripts also may run on client machine 102A.

Client machines 102A, 102N each may include a respective communication attendant system 130A, 130N providing one or more graphical user interfaces that allow users to visually browse, navigate, search, select, and use various services offered by IVR system 192. In one example, one or more communication attendant systems 130-130M receive data associated with IVR system 192 and maintain data flows to operate the IVR system 192 on behalf of a user. One or more of the communication attendant systems 130-130M then generate and display graphical user interfaces that allow a user to use one or more services offered by the IVR system 192.

In an example, one of the communication attendant systems 130-130M initiates communication with and performs operations involving the IVR system 192 on behalf of the user. The communication attendant system 130-130M also may provide authentication and other information associated with the user. In addition, the communication attendant system 130-130M may wait for a live person to respond to the communication, signal the user when a live person is responsive to the communication, and connect the user to the communication when the live person is responsive to the communication.

In various examples, communication attendant systems 130-130M may be provided to clients 102A, 102N by a third-party payment processing provider, merchant 190, technology vendor, or one or more other various parties. In addition, communication attendant systems 130-130M generally may be used to contact and operate interactive voice response (IVR) systems offered by any party, and are not specifically limited to interactions between merchants and consumers.

Client machines 102A, 102N include respective communication devices 106A-106N and digital wallets 108A-108N. In an example, communication devices 106A-106N generally refer to alternative or secondary communication devices of a user that allow the user to communicate with merchant 190, IVR system 192, support representative 194, communication attendant system(s) 130-130M, or generally any other party, computer system, or communication device.

Digital wallets 108A, 108N each generally refer to an electronic device or computer software running on an electronic device that allows a user to manage various personal credentials, accounts, and other assets. Examples of digital wallet assets may include, but are not limited to, one or more credit cards, debit cards, mobile payment accounts, money transfer accounts, loyalty cards, rewards cards, offers, coupons, bank accounts, checking accounts, investment accounts, electronic marketplace accounts, driver's licenses, government identification cards, public transit cards, employee IDs, fitness club cards, health benefit cards, etc.

In an example, digital wallet 108A, 108N assists a user in recording, maintaining, locating, searching, and effectively using data associated with the user's transactions. For example, digital wallet 108A, 108N may record and maintain data associated with user purchases. In one example, digital wallet 108A, 108N tracks payment methods, payment provider information, purchased products, merchant 190 information, store location, product manufacturers or providers, warranty policies of various parties involved with a transaction, customer service contact information for various parties associated with a transaction, etc.

Digital wallet 108A, 108N may use such information to assist a user in seeking and obtaining product support, warranty support, or replacement products. Digital wallet 108A, 108N also may track deposits, withdrawals, purchases, payments, sales, collections, donations and other financial or business-related transactions of a user, group of users, business, or any other entity.

Server machine 110 and communication attendant systems 130A-130M generally each include a respective data manager module 140-140M, interactive voice response (IVR) flow manager module 150-150M, user interface manager module 160-160M, and communication agent module 170-170M. In various examples, such modules may be combined, divided, and organized in various arrangements on one or more computing devices.

Merchant 190 generally refers to one or more parties that sell or otherwise provide products or services to various parties such as consumers, businesses, governments, non-profit organizations, etc. Merchant 190 generally may provide goods or services by having a physical presence, by operating online with a virtual presence, and/or with the assistance of one or more intermediate agents (e.g., brokers, handlers, shippers, etc.).

Merchant 190 includes communication attendant system 130M, interactive voice response (IVR) system 192, and support representative 194. In an example, merchant 190 optionally may provide one or more modules of communication attendant system 130M to facilitate interaction between consumers and the merchant 190 or IVR system 192.

Interactive voice response (IVR) system 192 generally refers to a specialized, telephony system that uses computer hardware, software, or network systems to perform various communication services, including functionality traditionally performed by telephone equipment. In an example, IVR system 192 allows a computer to interact with another party based on dual-tone multi-frequency (DTMF) tones or voice commands. For example, merchants 190 and other parties may use IVR system 192 to provide fully or partially automated service when responding to or placing calls.

In an example, IVR system 192 answers incoming user calls, interacts with users on both incoming and outbound calls, receives user input in the form of DTMF tones or voice commands, authenticates users on incoming and outbound calls, provides information to users on incoming and outbound calls, and routes incoming and outbound calls to various departments, extensions, mailboxes, and/or support representatives 194. Such services, generally allow merchants 190 and other parties to provide automated telephone service, call routing, self-service, and other options to users with a reduced number of support representatives 194 and during periods of time when support representatives 194 would not otherwise be available (e.g., nights, weekends, holidays, etc.).

In general, IVR system 192 is not limited to traditional telephony systems and may include other technologies involving communication between two or more different parties where automated communication services are provided. For example, IVR system 192 may include, but is not limited to specialized computer-based communication systems utilizing text, voice, video, web, augmented reality, virtual reality and/or any other forms of communication. In one example, IVR system 192 may include an automated support system, such as a virtual agent, chat bot, or other various types of automated online assistance. Further, IVR system 192 may include local, distributed, or cloud-based computer instructions for providing automated services.

Support representative 194 generally refers to a living person or human being who receives, answers, or is otherwise involved with and participating in a communication. For example, support representative 194 may include, but is not limited to, an operator, a customer service representative, a technical support representative, a receptionist, or any other living person who is responsive to a communication.

Server machine 110 may include one or more web servers 120 and application servers 122. Web server 120 may provide text, audio, image, and video content from server machine 110 or other sources (e.g., data store 180) to client machines 102A, 102N. Web server 120 also may provide web-based application services, business logic, and updates to client machines 102A, 102N. Client machines 102A, 102N may locate, access, and consume various forms of content and services from web server 120 using applications, such as a web browser, web servers, and various other types of computer applications, etc. Web server 120 also may receive text, audio, video, and image content from client machines 102A, 102N, which may be stored in data store 180 for preservation and/or sharing of content.

In an example, web server 120 is coupled to one or more application servers 122 that provide application services, data, business logic, and/or APIs to client machines 102A, 102N. In some examples, application servers 122 also may provide such services to client machines 102A, 102N without use of web server 120.

In an example, web server 120 may provide client machines 102A, 102N with access to one or more application server 122 services associated with communication attendant system 130. Such functionality also may be provided as part of one or more different web applications, standalone applications, systems, plug-ins, web browser extensions, and application programming interfaces (APIs), etc. In some examples, plug-ins and extensions generally may be referred to, individually or collectively, as “add-ons.”

In an example, client machines 102A, 102N may include an application associated with a service provided by server machine 110 (e.g., communication attendant system 130). For example, various types of computing devices (e.g., smart phones, smart televisions, tablet computers, smart wearable devices, smart home computer systems, etc.) may use applications to access services provided by server machine 110, to issue commands to server machine 110, and/or to receive content from server machine 110 without visiting or using web pages.

In an example, functions performed by server machine 110 also may be performed by client machines 102A, 102N, in whole or in part. In addition, the functionality attributed to a particular component may be performed by different or multiple components operating together. Further, server machine 110 may be accessed as a service provided by systems or devices via appropriate application programming interfaces (APIs), and thus is not limited to use with websites.

For example, client machines 102A, 102N and merchant 190 each may include a respective communication attendant system 130A-130M and/or one or more client modules of a respective communication attendant system 130A-130M for providing communication valet services to a user. Further, server machine 110 may include a respective communication attendant system 130 and/or one or more server-based modules of a communication attendant system 130.

In an example, data manager module 140 of communication attendant system 130 receives data associated with one or more interactive voice response systems (e.g., IVR system 192). For example, data manager module 140 may receive data and metadata describing various layout, structural, or operational aspects of IVR system 192. In one example, data manager module 140 receives and maintains IVR system 192 data for different interactive voice response systems offered by different and unrelated merchants 190.

In an example, IVR system 192 data and metadata may include, but is not limited to, IVR identification and access information, IVR security information, IVR configuration information, IVR data to be provided to users, text data, voice data, sound data, sound recordings, video data, speech data, language data, translated data, computer instructions, data links, web links, IVR data flows and structure, IVR data scripts, IVR menus, IVR data modules or units, IVR data associations and hierarchies, ordering and sequencing of IVR data, user input prompts, IVR selection options, IVR self-service data, etc. In one example, such IVR data allows communication attendant system(s) 130-130M to graphically and visually represent the flow and usage of IVR system 192 to a user, entirely, partially, incrementally, or in other forms that allow the user to invoke communication agent module 170-170M to operate the IVR system 192 on the user's behalf.

Data manager module 140 may gather, collect, and/or receive IVR system 192 data from one or more different sources. In an example, data manager module 140 receives IVR system 192 data from a party associated with the IVR system 192, such as merchant 190. Data manager module 140 also may receive IVR system 192 data from one or more associated or unassociated third parties, or other users possessing knowledge about the IVR system 192 (e.g., vendor, manufacturer, call center, etc.).

In an example, data manager module 140 receives IVR system 192 data via an ad-hoc or preexisting data feed, web service, or application programming interface (API). Such data may be provided, for example, as structured, unstructured, or semi-structured data. Data manager module 140 also may receive IVR system 192 data, for example, by crawling or observing behavior of the IVR system directly or with the assistance of a user. Further, IVR system 192 data may be provided by, updated by, or received from various parties and users via crowdsourcing. Crowdsourcing generally refers to the process of obtaining content or other information by soliciting contribution from a group of people (e.g., the public or an online community) in addition to or in lieu of traditional channels.

In an example, interactive voice response (IVR) flow manager module 150 of communication attendant system 130 maintains a data flow for each of a plurality of interactive voice response systems. For example, IVR flow manager module 150 may receive a data flow corresponding to an interactive voice response system or may create and maintain a data flow based on data or metadata associated with an interactive voice response system.

Data flow generally refers to data that represents an organization or structure of an interactive voice response system. For example, a dataflow may represent one or more of a hierarchy of menus or questions, navigation paths, a decision tree, a flowchart, decision points, user options, etc. In one example, IVR flow manager 150 maintains one or more mappings between graphical user interface options presented to a user and a dataflow associated with IVR system 192 to allow automated operation of the IVR system 192 on behalf of the user without the user's involvement.

In an example, IVR flow manager module 150 maintains a dataflow for IVR system 192 to allow automated operation of the IVR system 192 on behalf of the user by communication agent module 170. In one example, IVR flow manager module 150 maintains multiple data flows for IVR system 192 based on the availability of different data flows offered by country, region, language, or any other factors. IVR flow manager module 150 also may maintain data flows for interactive voice response systems associated with different parties. For example, IVR flow manager module 150 may maintain data flows for each interactive voice response system operated by merchant 190. IVR dataflow manager module 150 also may maintain data flows for different interactive voice response systems offered by various unrelated parties.

In an example, user interface manager module 160 generates a graphical user interface that allows a user to visually select and use services offered by IVR system 192. For example, user interface manager module 160 may generate one or more graphical user interfaces that allow user to visually browse, navigate, explore, select, and directly or indirectly invoke IVR system 192 functionality. Such graphical user interfaces generally may include, but are not limited to, full, partial, incremental, simplified, condensed, consolidated or any other visual representation of IVR system 192.

In an example, user interface manager module 160 generates and displays a graphical user interface that allows the user to locate one or more services offered by IVR system 192 using a visual search interface. For example, a user wishing to “change a password” or to “obtain an account balance” may enter and search for such functionality in IVR system 192 using a graphical user interface. The same or a different graphical user interface then may be used to collect information from the user. In one example, the collected information allows communication agent module 170 to initiate communication with and operate IVR system 192 on behalf of the user without the user's involvement.

In an example, user interface manager module 160 generates and displays one or more graphical user interfaces that allow users to navigate and select functionality provided by the IVR system 192. For example, a graphical user interface may walk a user through a series of questions and responses that mirror or mimic, in whole or in part, organization and structure of IVR system 192. In one example, user interface manager module 160 generates a graphical user interface for IVR system 192 based on data associated with the IVR system 192. Further, options and selections provided on a graphical user interface may be mapped to a subset or superset of functionality actually offered by IVR system 192.

In an example, communication agent module 170 of communication attendant system 130 receives user selections associated with IVR system 192 from the graphical user interface provided by user interface manager module 160. Communication agent module 170 then initiates a communication to perform one or more actions involving IVR system 192 on behalf of the user. In one example, communication agent module 170 receives user selections via a web or mobile application interface. Communication agent module 170 then initiates a telephone, voice, or network communication to communicate with IVR system 192 on behalf of the user based on the user selections. In various examples, communication agent module 170 may initiate the communication immediately, with some delay, or at a time scheduled by the user. The communication also may be scheduled for a date and time that is free on the user's calendar to ensure the user is available to communicate with support representative 194, if needed.

In an example, communication agent module 170 operates IVR system 192 on behalf of the user in view of a user selection received from the graphical user interface. Communication agent module 170 also may provide IVR system 192 with authentication and other information received from the user via the graphical user interface. Communication agent module 170 further may provide IVR system 192 with user information received from digital wallet 108A, a user profile, a user account, a digital receipt, or any other source of user information.

In an example, communication agent module 170 maintains a communication involving IVR system 192 on behalf of the user when waiting for a response from support representative 194. For example, communication agent module 170 may wait on behalf of the user after IVR system 192 transfers or places a communication on hold. Communication agent module 170 also may detect when support representative 194 is responsive to a communication.

In an example, communication agent module 170 signals client machine 102A or another communication device 106A of a user when support representative 194 is responsive to a communication associated with IVR system 192. Communication agent module 170 then connects client machine 102A or communication device 106A to the communication, allowing the user to speak with support representative 194.

As such, a user may instruct communication agent module 170 to contact IVR system 192 on behalf of the user without the user's involvement. Communication agent module 170 then may contact IVR system 192, operate and provide information to IVR system 192, wait for a live person to answer the communication, and then contact and connect the user to the communication once a live person is available.

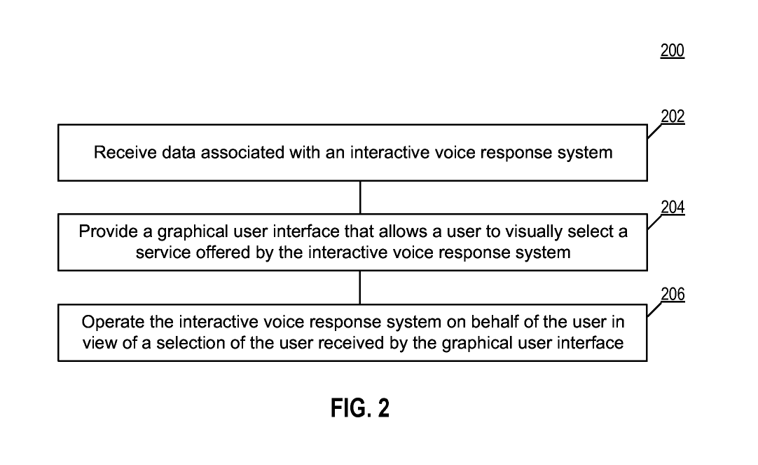

FIG. 2 is a flow diagram for providing an interactive voice response (IVR) valet service, according to an example of the present disclosure. The method 200 may be performed by processing logic that may comprise hardware (circuitry, dedicated logic, programmable logic, microcode, etc.), software (such as instructions run on a general purpose computer system, dedicated machine, or processing device), firmware, or a combination thereof. Examples in the method 200 are described with respect to communication attendant system 130 for the sake of consistency. In addition, such examples also generally apply to other communication attendant system 130, 130N, 130M examples described herein.

Method 200 begins at block 202 when data manager module 140 of communication attendant system 130 receives data associated with an interactive voice response system. In an example, data manager module receives data about one or more different IVR systems 192 associated with various parties. For example, data manager module 140 may receive data associated with an IVR system of a retailer, an IVR system a manufacturer, an IVR system of a payment provider, an IVR system of a warranty provider, and various other IVR systems associated with other unrelated parties. Thus, data manager module 140 and an associated IVR flow manager module 150 may maintain inventory data, metadata, and data flows associated with various IVR systems 192 offered by different organizations.

In an example, data manager module 140 receives data associated with an interactive voice response system from one or more different sources using one or more different methods. For example, data manager module 140 may receive IVR system 192 data from a primary source, secondary source, or other party that provides, operates, or manages IVR system 192. Data manager module 140 also may receive IVR system 192 data from various individuals via crowdsourcing. Further, data manager module 140 may collect or extract data from an IVR system 192 by interacting with the IVR system 192 directly or observing a user session involving the IVR system 192.

In an example, data manager module 140 receives IVR menu layouts for different IVR systems 192 of various companies. In one example, data manager module 140 receives IVR system 192 menu layout data and updates from Internet uses via the crowdsourcing of such data. In one example, data manager module 140 receives IVR system 192 menu layout data and updates from the merchant 190 associated with the IVR system 192. For example, data manager module 140 may receive such data from the merchant 190 via a data feed, web service, application programming interface (API), database, or other data source.

At block 204, user interface manager module 160 of communication attendant system 130 provides a graphical user interface that allows a user to visually select services offered by the interactive voice response system. In an example, user interface manager module 160 generates a graphical user interface to display to the user based on data associated with IVR system 192. For example, user interface manager module 160 may generate a graphical user interface corresponding to structure, navigation, and user options associated with IVR system 192. User interface manager module 160 also may generate a consolidated or simplified graphical user interface to allow a user to locate and select services provided by IVR system 192 without enduring complexity associated with IVR system 192 menus and options.

In an example, a graphical user interface provided by user interface manager module 160 allows a user to search for IVR system 192 functionality and services without navigating menus, hierarchies, indices, or taxonomies. For example, a user may search for “password reset” and be directed to a corresponding graphical user interface, such as a web or mobile application data input form. The data input form then allows the user to input authentication and other information to use the service. Communication agent module 170 then may use such information to complete the transaction with IVR system 192 on behalf of the user without the user's involvement.

At block 206, communication agent module 170 of communication attendant system 130 operates the interactive voice response system on behalf of the user view of a selection of the user received from the graphical user interface. In an example, communication agent module 170 receives user selections associated from the graphical user interface associated with IVR system 192. The communication agent module 170 then contacts the IVR system 192 using a communication platform or an application programming interface (API) of the IVR system 192 to perform one or more actions on behalf of the user.

In an example, communication agent module 170 initiates a telephone, voice, or network call to contact and operate IVR system 192 on behalf of the user. For example, communication agent module 170 may complete one or more tasks or activities for the user by interacting directly with IVR system 192 based on user selections received from a graphical user interface. In one example, communication agent module 170 notifies the user about a status of a communication associated with IVR system 192. For example, communication agent module 170 may indicate that a transaction has been completed on behalf of the user or that a pending communication has been transferred and is waiting on hold for support representative 194 to respond.

In an example, communication agent module 170 waits on behalf of the user when a pending communication is on hold or awaiting a response from support representative 194. For example, communication agent module 170 may maintain a user's position in a queue of calls until a live person is ready to speak with the user. In one example, communication agent module 170 monitors a pending communication, determines that support representative 194 is responsive to the communication, and signals client machine 102A or another communication device 106A of the user. Communication agent module 170 then connects the client machine 102A or the communication device 106A to allow the user to speak with support representative 194. Communication agent module 170 then may drop off the communication or wait for further instruction from the user via a graphical user interface associated with IVR system 192.

In an example, the digital wallet 108A associated with a user analyzes transactional data based on a user request. For example, a user may instruct digital wallet 108A to find parties or products associated with a purchase or other transaction based on one or more search criteria. In one example, a user requests digital wallet 108A assistance with obtaining support for a product purchased by the user in a transaction involving digital wallet 108A.

In an example, digital wallet 108A identifies one or more parties associated with the purchase that can provide support for the product. For example, digital wallet 108A may examine and analyze warranty data provided by stores, manufacturers, payment providers, supplemental warranty providers, and possibly other parties able to provide warranty or product replacement support. Digital wallet 108A then may determine which of the one or more parties is best able to provide the warranty support for the purchased product based on user preferences. For example, digital wallet 108A may determine that the best party for the user provides free warranty support, the fastest service, the best quality, etc. Digital wallet 108A also may determine the best option for the user based on one or more other criteria as indicated by warranty policies, customer reviews, provider capabilities, and other factors in view of user preferences.

In an example, digital wallet 108A presents one of more of the warranty support options to the user and suggests the best option determined for the user. Digital wallet 108A receives a warranty support selection from the user and then invokes communication agent module 170 to contact the party associated with the user's warranty support selection. In one example, communication agent module 170 then operates an associated IVR system 192 to place the user in touch with support representative 194. Other examples for automated routing to an appropriate person or place in the IVR system based, in part, on digital wallet 108A (such as purchases made through digital wallet 108A) include return services, product replacement services, accessory services, and the like.

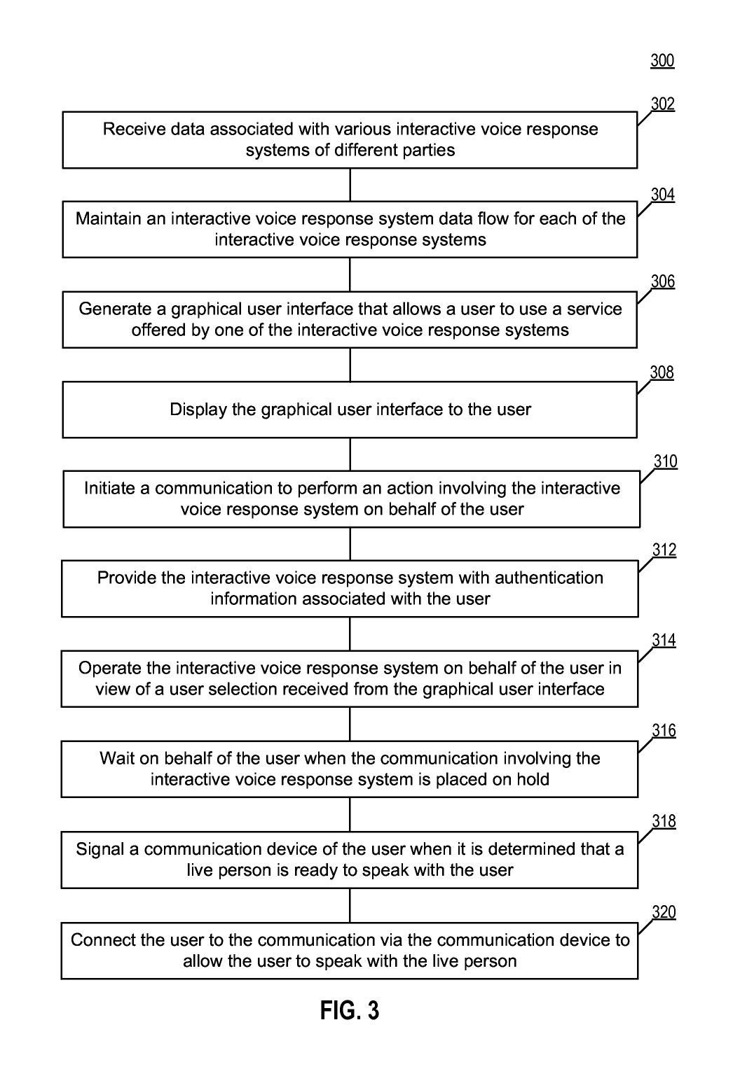

FIG. 3 is a flow diagram for providing an interactive voice response (IVR) valet service for interactive voice response systems of different merchants, according to an example of the present disclosure. The method 300 may be performed by processing logic that may comprise hardware (circuitry, dedicated logic, programmable logic, microcode, etc.), software (such as instructions run on a general purpose computer system, dedicated machine, or processing device), firmware, or a combination thereof. Examples in the method 300 are described with respect to communication attendant system 130 for the sake of consistency. Additionally, such examples also generally apply to other communication attendant system 130, 130N, 130M examples described herein.

Method 300 begins at block 302 when data manager module 140 of communication attendant system 130 receives data associated with various interactive voice response systems of different parties. In an example, data manager module 140 receives data associated with various IVR systems 192 of merchants 190. In one example, data manager module 140 receives data associated with IVR system 192 from a party associated with a respective IVR system 192 or from one or more other users through crowdsourcing of the data. Further, data manager module 140 also may collect or extract data from an IVR system 192 when interacting with the IVR system 192 or by monitoring a user session involving IVR system 192.

At block 304, interactive voice response (IVR) flow manager 150 of communication attendant system 130 maintains a plurality of IVR data flows for the interactive voice response systems of the different parties. In an example, IVR flow manager 150 stores and updates IVR data flows associated with different IVR systems 192 of various merchants 190. In one example, the data flows maintained by IVR flow manager 150 are used to generate graphical user interfaces for each IVR system 192 and to operate each of the IVR systems 192 automatically on behalf of a user. In one example, an interactive voice response system data flow provides communication agent module 170 with information about the organization, structure, and navigation routes of the IVR system 192. Communication agent module 170 then may use such information about the IVR system 192 to carry out various tasks on behalf of users.

At block 306, user interface manager module 160 of communication attendant system 130 generates a graphical user interface that allows a user to use one or more services offered by the interactive voice response system. In an example, user interface manager module 160 generates the graphical user interface based on one or more of IVR system 192 data, metadata, and/or data flows. In one example, graphical user interfaces generated for the IVR system 192 allow the user to browse, navigate, explore, select, and instruct communication agent module 170 to perform one or more tasks using IVR system 192 without further involvement from the user.

In an example, user interface manager module 160 retrieves one or more authentication challenges or security questions from IVR system 192. For example, user interface manager module 160 may contact IVR system prior to or as part of generating of a graphical user interface associated with the IVR system 192 to obtain random, semi-random, or rotating authentication challenges and security questions. User interface manager module 160 then may include such challenges and questions on a generated user interface provided to the user. Further, user interface manager module 160 then may collect and provide user responses to the challenges and questions to IVR system 192, for example, to authenticate and authorize actions performed on behalf of the user by communication agent module 170.

At block 308, user interface manager module 160 of communication attendant system 130 provides the graphical user interface to the user. In an example, user interface manager module 160 displays a graphical user interface generated for IVR system 192 to a user on client machine 102A. User interface manager module 160 then receives user input and selections from the graphical user interface, which communication agent module uses to operate IVR system 192 on behalf of the user.

In an example, user interface manager module 160 provides the user with self-service information from IVR system 192 on the graphical user interface. For example, user interface manager module 160 may display, play, or offer text, sound, audio, video or other content received or extracted from IVR system 192. In addition, self-service content may be submitted by one or more other parties, such as other users. In one example, user interface manager module 160 includes or embeds self-service information into the graphical user interface to allow the user to directly access such information. Thus, the user may read self-service messages and play self-service sound recordings or videos that would otherwise be hidden in the menus of IVR system 192.

In an example, user interface manager module 160 provides one or more interactive voice response system self-service options on a graphical user interface generated for IVR system 192. For example, user interface manager module 160 may front load self-service or other customer support information such as audio recordings, video recordings, transcribed text, computer-narrated text, self-help articles, and other various content associated with IVR system 192 on a web site, mobile application, or other graphical user interface.

In an example, a graphical user interface associated with IVR system 192 comprises one or more objects or links that provide access to self-service information associated with the IVR system 192. For example, self-service information may be extracted, collected, or recorded from IVR system 192. Also, self-service information may be received directly from merchant 190 or as crowd sourced data provided by one or more Internet users. In one example, a graphical user interface generated for IVR system 192 allows a user to play an audio recording, read an article, or watch a video about a password reset or other issue by selecting one or more links displayed on the graphical user interface.

At block 310, communication agent module 170 of communication attendant system 130 initiates a communication to perform an action involving the interactive voice response system on behalf of the user. In an example, communication agent module 170 of communication attendant system 130 receives the user input and selections from the graphical user interface associated with IVR system 192. Communication agent module 170 then initiates a communication to perform one or more actions involving the IVR system 192 on behalf of the user. For example, the communication agent module 170 may initiate a telephone call, voice call, or network communication to operate IVR system 192 on behalf of the user according to the input and selections received from the user.

At block 312, communication agent module 170 of communication attendant system 130 provides user authentication information to the interactive voice response system. In an example, communication agent module 170 provides IVR system 192 with user authentication information prior to performing one or more actions on behalf of the user. Communication agent module 170 also may provide one or more forms of authentication information to IVR system 192 to allow pre-authentication of a user, for example, by IVR system 192 or support representative 194 (e.g., before speaking with a user).

At block 314, communication agent module 170 of communication attendant system 130 operates the IVR system 192 on behalf of the user in view of a user selection received from the graphical user interface. In an example, communication agent module 170 navigates and operates IVR system 192 to perform one or more activities on behalf of the user. In one example, communication agent module 170 utilizes mapping information associating one or more user selections with a data flow of IVR system 192 to perform the activities for the user. In addition, communication agent module 170 may play one or more tones, sounds, or words to operate an audible or audibly-controlled IVR system 192.

In some examples, communication agent module 170 may end a communication used to perform an activity involving IVR system 192 on behalf of the user. For example, the communication may be terminated upon completion or failure. Communication agent module 170 then may notify the user about the status of the communication and which activities were completed or not completed. In other examples, communication agent module 170 may perform one or more activities involving the IVR system 192, which then may transfer the communication to support representative 194 or another live person.

At block 316, communication agent module 170 of communication attendant system 130 waits on behalf of the user when the communication associated with the interactive voice response system is placed on hold. In an example, communication agent module 170 detects that IVR system 192 has transferred the communication and that the communication is being held for the next available person in a queue of calls. Communication agent module 170 then waits on hold until the support representative 194 is ready to speak with the user.

In some examples, communication agent module 170 provides information about the user to IVR system 192 via an application programming interface (API), web service, or other data channel. IVR system 192 then provides the information to support representative 194 to allow support representative to pre-authenticate the user, to verify information about the user, or to review information describing a reason for the communication. Such information may be provided prior to or when the support representative is connected to the communication.

At block 318, communication agent module 170 of communication attendant system 130 signals a communication device of the user when it is determined that a support representative 194 or other person is ready to speak with the user regarding the communication. In an example, communication agent module 170 detects when the support representative 194 is responsive to a pending communication. Communication agent module 170 then signals client machine 102A and/or communication device 106A of the user. For example, communication agent module 170 may call or notify the user that support representative 194 is available to speak on an active communication.

At block 320, communication agent module 170 of communication attendant system 130 connects the communication device of the user to the communication associated with the interactive voice response system to allow the user to speak with the support representative 194. In an example, communication agent module 170 automatically connects the user to the communication without signaling a device of the user when the support representative 194 is detected. In some examples, communication agent module 170 remains on the communication with the user and the support representative 194, awaiting further instruction from the user via a graphical user interface. Communication agent module 170 also may exit or leave the communication once the user and the support representative 194 are connected, for example, automatically or based on an instruction from the user.

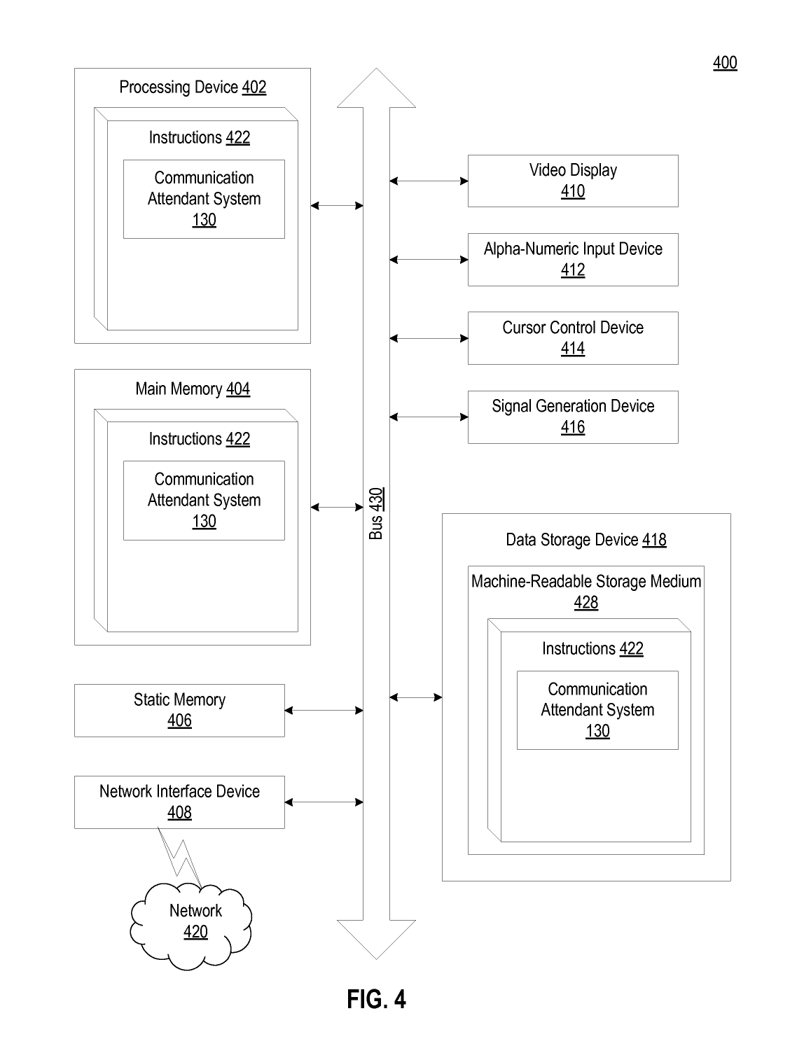

FIG. 4 illustrates a diagram of a machine in the exemplary form of a computer system 400, within which a set of instructions for causing the machine to perform any one or more of the methodologies discussed herein may be executed. In other examples, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a wearable computing device, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 418, which communicate with each other via a bus 430.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 also may be one or more special-purpose processing devices such as an application specific integrated circuit (ASIC), a field programmable gate array (FPGA), a digital signal processor (DSP), network processor, or the like. The processor 402 is configured to execute instructions 422 for performing the operations and steps discussed herein.

The computer system 400 also may include a network interface device 408. The computer system 400 may further include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The data storage device 418 may include a computer-readable storage medium 428 on which is stored one or more sets of instructions 422 (e.g., software computer instructions) embodying any one or more of the methodologies or functions described herein. The instructions 422 also may reside, completely or at least partially, within the main memory 404 and/or within the processor 402 during execution thereof by the computer system 400, the main memory 404 and the processor 402 also constituting computer-readable storage media. The instructions 422 may be transmitted or received over a network 420 via the network interface device 408.

In one example, the instructions 422 include instructions for one or more modules of a customer management system (e.g., communication attendant system 130 of FIG. 1) and/or a software library containing methods that call a communication attendant system 130. While the computer-readable storage medium 428 (machine-readable storage medium) is shown as an example to be a single medium, the term “computer-readable storage medium” should be taken to include a single medium or multiple media (e.g., a centralized or distributed database, and/or associated caches and servers) that store the one or more sets of instructions. The term “computer-readable storage medium” also may include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Numerous details are set forth in the foregoing description. However, it will be apparent to one of ordinary skill in the art having the benefit of this disclosure that the present disclosure may be practiced without these specific details. In some instances, well-known structures and devices are shown in block diagram form, rather than in detail, to avoid obscuring the present disclosure.

Some portions of the detailed description have been presented in terms of algorithms and symbolic representations of operations on data bits within a computer memory. Here, an algorithm is generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing,” “comparing,” “associating,” “applying,” “transmitting,” “receiving,” “processing” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain examples of the present disclosure also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other examples will be apparent to those of skill in the art upon reading and understanding the above description. The scope of the disclosure therefore should be determined with reference to the appended claims, along with the full scope of equivalents to which such claims are entitled.

1. A computer system, comprising:
a non-transitory memory; and
one or more hardware processors coupled to the non-transitory memory and configured to read instructions from the non-transitory memory to cause the computer system to perform operations comprising:
collecting data from an interactive voice response system without involvement of a user during a first communication session with the interactive voice response system;
providing a graphical user interface generated based on the data collected from the interactive voice response system, the graphical user interface allowing the user to graphically select a service available from the interactive voice response system without interacting with the interactive voice response system;
receiving user input associated with the interactive voice response system via the graphical user interface;
initiating a second communication session with the interactive voice response system without involvement of the user based on the user input; and
issuing one or more commands to the interactive voice response system during the second communication session without involvement of the user based on the user input.

2. The computer system of claim 1, wherein the operations further comprise:
selecting the graphical user interface based on transaction data associated with a digital wallet of the user.

3. The computer system of claim 1, wherein the operations further comprise:
providing, via the graphical user interface, self-service information extracted from the interactive voice system during the collecting.

4. The computer system of claim 1, wherein the graphical user interface allows the user to use a service provided by the interactive voice response system without participating in a telephonic communication session with the interactive voice response system.

5. The computer system of claim 1, wherein the graphical user interface allows the user to search for one or more services associated with the interactive voice response system.

6. The computer system of claim 1, wherein the operations further comprise:
maintaining a data flow for navigating the interactive voice response system based on the collecting.

7. The computer system of claim 1, wherein the operations further comprise:
maintaining a plurality of data flows corresponding to respective interactive voice response systems associated with different parties.

8. The computer system of claim 1, wherein the operations further comprise:
maintaining a mapping between an option provided via the graphical user interface and a data flow for the interactive voice response system.

9. The computer system of claim 1, wherein the operations further comprise:
recording a self-service message provided by the interactive voice response system during the first communication session as part of the collecting.

10. The computer system of claim 1, wherein the second communication session is initiated at a later time scheduled by the user.

11. The computer system of claim 1, wherein the operations further comprise:
waiting on hold during the second communication session with the interactive voice response system without involving the user.

12. The computer system of claim 1, wherein the operations further comprise:
detecting that a live person is responsive to the second communication session with the interactive voice response system.

13. The computer system of claim 1, wherein the operations further comprise:
notifying the user about a status of the second communication session with the interactive voice response system.

14. The computer system of claim 1, wherein the operations further comprise:
signaling a communication device of the user when a live person is responsive to the second communication session.

15. The computer system of claim 1, wherein the operations further comprise:
connecting a computing device of the user to the second communication session after detecting involvement of a live person on the second communication session.

16. The computer system of claim 1, wherein the operations further comprise:
providing the interactive voice response system with authentication information associated with the user.

17. The computer system of claim 16, wherein the authentication information is received from the user via the graphical user interface.

18. The computer system of claim 1, wherein the graphical user interface is associated with a digital wallet.

19. A non-transitory machine-readable medium having stored thereon machine-readable instructions executable to cause a machine to perform operations comprising:
collecting data about an interactive voice response system during a first communication session with the interactive voice response system, the first communication session being operated without human involvement;
providing a graphical user interface generated from the data collected from the interactive voice response system, the graphical user interface allowing a user to graphically select a service available from the interactive voice response system without participating in a communication session with the interactive voice response system;
receiving user input associated with the interactive voice response system via the graphical user interface prior to establishing a second communication session with the interactive voice response system;
initiating the second communication session with the interactive voice response system without participation of the user based on the user input; and
issuing one or more commands to the interactive voice response system during the second communication session without participation of the user based on the user input.

20. A computer-implemented method, comprising:
collecting, by one or more processing devices, data from an interactive voice response system by operating the interactive voice response system without human participation during a first communication session;
providing, by one or more of the processing devices, a graphical user interface generated based on the data collected from the interactive voice response system, the graphical user interface allowing a user to select a service available from the interactive voice response system without participating in a subsequent communication session with the interactive voice response system;
receiving, by one or more of the processing devices, a user selection associated with the interactive voice response system from the graphical user interface;
initiating, by one or more of the processing devices, a second communication session with the interactive voice response system without presence of the user based on the user selection previously received from the graphical user interface; and
issuing, by one or more of the processing devices, an audible command to the interactive voice response system during the second communication session without presence of the user based on the user selection previously received from the graphical user interface.
